(19) United States
(12) Patent Application Publication
(10) Pub. No.: US 2007/0146471 A1
(43) Pub. Date: Jun. 28, 2007

(54) Thermal recording apparatus

(75) Inventors: Akira Nakamura, Tokyo (JP); Taku Naitou, Tokyo (JP); Hiroshi Watanabe, Tokyo (JP); Masayuki Suzuki, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: RISO KAGAKU CORPORATION, Tokyo (JP)

(21) Appl. No.: 11/638,549

(22) Filed: Dec. 14, 2006

(30) Foreign Application Priority Data
Dec. 22, 2005 (JP) 2005-369514

(51) Int. Cl. G01D 15/10

(52) U.S. Cl. 347/220

(57) ABSTRACT

There is provided a thermal recording apparatus that transports a thermal recording medium in a sub-scanning direction in close contact with a thermal print head including plural heating elements juxtaposed in a main scanning direction, and performs thermal recording on the thermal recording medium by arbitrarily driving the heating elements, including: a sucking unit that is provided in the vicinity of the heating elements, and sucks and transportably holds the thermal recording medium, and a transporting unit that is provided in the downstream side of the heating elements with respect to a transportation direction of the thermal recording medium, and transports the thermal recording medium, wherein the thermal recording apparatus transports the thermal recording medium in close contact with the heating elements by transporting the thermal recording medium by the transporting unit while sucking it by the sucking unit, and performs thermal recording on the thermal recording medium by arbitrarily driving the heating elements.

### BACKGROUND OF THE INVENTION

1. Field of the Invention

The present invention relates to a thermal recording apparatus that transports a thermal recording medium (stencil paper and thermal paper) in a sub-scanning direction in close contact with a thermal print head including plural heating elements juxtaposed in a main scanning direction, and performs thermal recording on the thermal recording medium by arbitrarily driving the heating elements.

2. Description of Related Art

As described in Japanese Published Unexamined Patent Application No. 2000-318236, as a thermal recording apparatus employing a thermal print head (hereinafter referred to as TPH) including plural heating elements, a thermal recording apparatus formed of a combination of a TPH and platen rollers is known. In the thermal recording apparatus, the TPH is fixed in a predetermined position, and platen rollers are rotationally driven in contact with it under a predetermined load. A thermal recording medium such as stencil paper and thermal paper is transported while being sandwiched between the TPH and the platen rollers, and in the meantime, by arbitrarily driving the heating elements, the thermal recording medium is subjected to desired thermal recording (thermal perforation for stencil paper).

Thus, a known conventional thermal recording apparatus employing a TPH is only the one that transports stencil paper in close contact with the heating elements of the TPH (fixed member) by combining the TPH and platen rollers (rotation members).

### (1) Recognition of Problems by the Present Inventors

The present inventors elucidate the problems of the above-described conventional thermal recording apparatus, and in order to solve the problems, assumes a case of thermally perforating stencil paper (plate making) as a concrete example of thermally recording on a thermal recording medium by a TPH, and carefully studied conditions for the case as described below. The stencil paper has a structure with a thermally-melting film pasted to a porous support sheet, and holes are formed by the film being melted by the heating elements of the TPH.

The term plate making means forming an image by forming independent minute holes on stencil paper. To achieve this, holes of an arbitrary size need to be formed in arbitrary positions of stencil paper. Therefore, a plate-making unit (a plate-making device as the above-described thermal recording apparatus) needs to have two functions: forming holes of an arbitrary size (perforation) and forming holes in arbitrary positions (transportation).

### (2) Requirements for Perforation

A condition necessary to achieve the perforation function is to bring the TPH into close contact with a film of stencil paper. The present inventors conceive that this does not necessarily require pressing the stencil paper against the TPH with a great force.

However, in conventional plate-making units, when stencil paper is to be brought into close contact with the TPH, since the surface of TPH and the surface of the stencil paper are not flat, portions incapable of close contact are generated, so that perforation failure inevitably occurs. Accordingly, in conventional plate-making units, pressure of the platen rollers applied to the TPH was set large to bring the stencil paper into fully close contact with the surface of the TPH (e.g., 80 to 100 N).

Application of a high pressure to the TPH plus the use of platen rollers posed the following problems.

Specifically, the increased pressure requires useless energy, and parts subjected to high pressure are required to have high strength, resulting in a cost increase.

The increased pressure distorts the TPH and the platen rollers and disturbs pressure balance, causing failures such as perforations not formed normally in a central portion of stencil paper.

Constant application of such a high pressure causes a part of the circumferential face of the cylindrical platen rollers pressed against the TPH to be pressed and sectionally deformed into a D shape. As a result, during transportation (during plate making), disturbance occurs in pressure applied to the stencil paper by the platen rollers, causing transportation irregularities and perforation failures. Accordingly, although it is technologically not impossible to provide a special mechanism such as a TPH pressure dissipating mechanism to dissipate the high pressure applied between the platen rollers and the TPH when the plate-making unit is not used, the whole plate-making unit becomes large in size and the number of parts increases, so that manufacturing costs increase.

### (3) Requirements for Highly Accurate Transportation

The present inventors conceive that a condition necessary to realize a function of highly accurate transportation is to provide a transportation unit having a high transportation force to suppress slips.

However, conventional plate-making units have a transportation mechanism with platen rollers (rotation member) combined with a TPH (fixed member), and deliver stencil paper while being rubbed against the TPH by the platen rollers. Therefore, transportation power is so weak that slips may occur to deviate perforation positions, producing a deformed perforated image.

As described above, according to conventional plate-making units, since transportation power is weak, transportation has become unstable because of temporal change and variations of the surface of stencil paper, and an image has contracted. The temporal change refers significant reduction in grip force because of the deformation of the platen rollers pressed against the TPH with high pressure, and an increase in slip tendency because of transfer of silicon oil applied as a stripping agent to the surface of stencil paper to the platen rollers. The variations of the surface of stencil paper mean that since stencil paper is generally wound in a roll and since stencil paper nearer to the core is wound with a smaller curvature, the bumps and dips of a porous support of the stencil paper are transferred to a contacting film, and the area of contact with the platen rollers becomes small because of the bumps and dips occurring in the film, so that slips become liable to occur.

Thus, in the conventional plate-making units (plate-making devices as thermal recording devices) that press a TPH (fixed member) and platen rollers (rotation member) against each other, and transport stencil paper while bringing the stencil paper into close contact with heating elements of the TPH, there have been problems described above in two functions: the perforation function for forming holes of an arbitrary size and the transportation function for forming holes in arbitrary positions.

The present invention has been made to solve the above-described problems, and in a thermal recording apparatus employing a TPH, aims at achieving two functions, the perforation function and the transportation function, with high accuracy by adopting a wholly new mechanism, completely apart from the conventional structures with platen rollers employed.

### SUMMARY OF THE INVENTION

The thermal recording apparatus described in claim 1 transports a thermal recording medium in a sub-scanning direction in close contact with a thermal print head including plural heating elements juxtaposed in a main scanning direction, and performs thermal recording on the thermal recording medium by arbitrarily driving the heating elements.

The thermal recording apparatus includes a sucking unit that is provided in the vicinity of the heating elements, and sucks and transportably holds the thermal recording medium, and a transporting unit that is provided in the downstream side of the heating elements with respect to a transportation direction of the thermal recording medium, and transports the thermal recording medium. The thermal recording apparatus transports the thermal recording medium in close contact with the heating elements by transporting the thermal recording medium by the transporting unit while sucking it by the sucking unit, and performs thermal recording on the thermal recording medium by arbitrarily driving the heating elements.

According to the thermal recording apparatus described in claim 2, in the thermal recording apparatus described in claim 1, the thermal recording medium is stencil paper, and the sucking unit is provided at least in the upstream side of the heating elements.

According to the thermal recording apparatus described in claim 3, in the thermal recording apparatus described in claim 1, the thermal recording medium is thermal paper, and the sucking unit is provided in at least one of the upstream side and the downstream side of the heating elements.

According to the thermal recording apparatus described in claim 4, in the thermal recording apparatus described in claim 1, the sucking unit includes a sucking force detecting unit that detects a suction force with which the sucking unit sucks the thermal recording medium.

The thermal recording apparatus described in claim 5, in the thermal recording apparatus described in claim 4, includes a control unit that controls the suction force of the sucking unit according to a detection result of the suction force detecting unit.

According to the thermal recording apparatus described in claim 6, in the thermal recording apparatus described in claim 1, the sucking unit has a suction opening with a main scanning direction of the thermal recording medium as a longitudinal direction, and a length of the suction opening in the main scanning direction is smaller than a width of the thermal recording medium in the main scanning direction.

According to the thermal recording apparatus described in claim 7, in the thermal recording apparatus described in claim 6, a width of the heating elements in the main scanning direction is smaller than the length of the suction opening in the main scanning direction.

### [Addition]

According to the thermal recording apparatus described in claim 8, in the thermal recording apparatus described in claim 1, a surface of the thermal print head provided with the heating elements and the sucking unit is of convex shape, curved in both of a forward position and a backward position of the heating elements and the sucking unit with respect to a transportation direction of the thermal recording medium, and the thermal recording medium transported by the transporting unit contacts closely with the surface in the both positions.

### BRIEF DESCRIPTION OF THE DRAWINGS

FIG. 1 is a structural drawing of a first embodiment as viewed from a sightline parallel to a main scanning direction;

FIG. 2 is a structural drawing of a second embodiment as viewed from a sightline parallel to a main scanning direction;

FIG. 3 is a structural drawing of a third embodiment as viewed from a sightline parallel to a main scanning direction;

FIG. 4 is a structural drawing of a fourth embodiment as viewed from a sightline parallel to a main scanning direction;

FIG. 5 is a structural drawing of a fifth embodiment as viewed from a sightline parallel to a main scanning direction;

FIG. 6 is a structural drawing of a sixth embodiment as viewed from a sightline parallel to a main scanning direction;

FIG. 7 is a structural drawing of a seventh embodiment as viewed from a sightline parallel to a main scanning direction;

FIG. 8 is a structural drawing of an eighth embodiment as viewed from a sightline parallel to a main scanning direction;

FIG. 9 is a structural drawing showing a use state of stencil paper in a roll in an embodiment as viewed from a sightline parallel to a main scanning direction; and

FIG. 10 is a structural drawing of an embodiment having a surficially curved thermal print head as viewed from a sightline parallel to a main scanning direction.

### DETAILED DESCRIPTION OF THE PREFERRED EMBODIMENTS

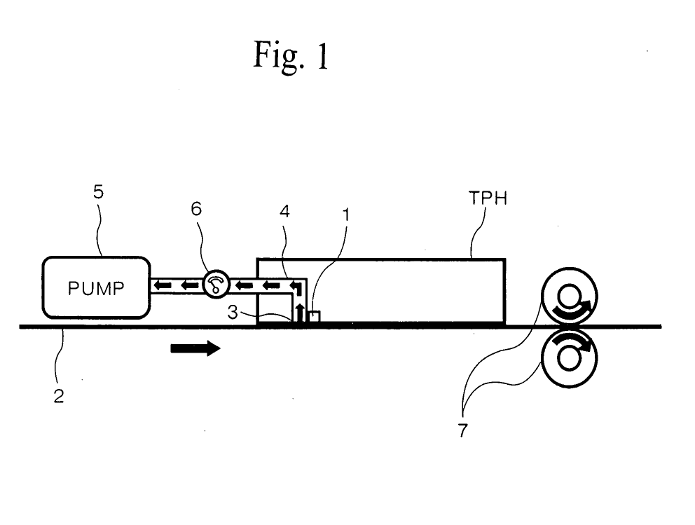

Preferred embodiments of the present invention will be described in detail with reference to FIGS. 1 to 9.

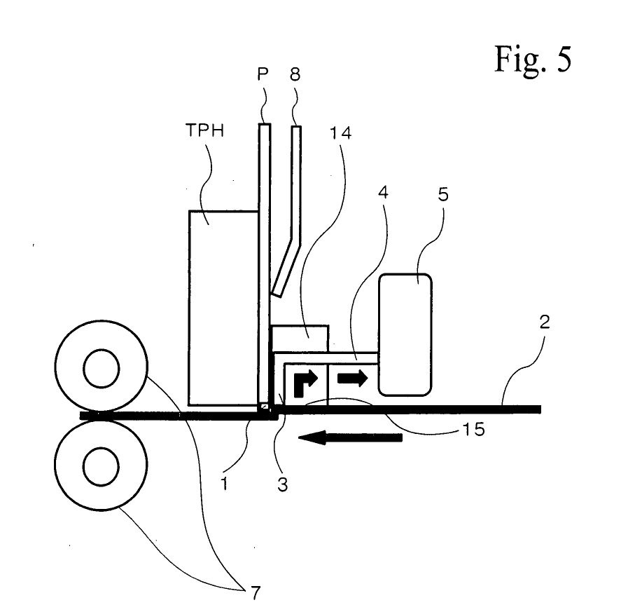

This embodiment relates to a plate-making device as a thermal recording apparatus, and uses stencil paper as a thermal recording medium. The stencil paper is wound up like a roll and delivered according to use. Although not shown in the drawings, in drawings 1 to 4, and 6 to 8, components from a unit for feeding sheet-type stencil paper to a roll of stencil paper are disposed to the left and the stencil paper is delivered to the right. In FIG. 5, components from a unit for feeding sheet-type stencil paper to a roll of stencil paper are disposed to the right and the stencil paper is delivered to the left.

### (1) First Embodiment (FIG. 1)

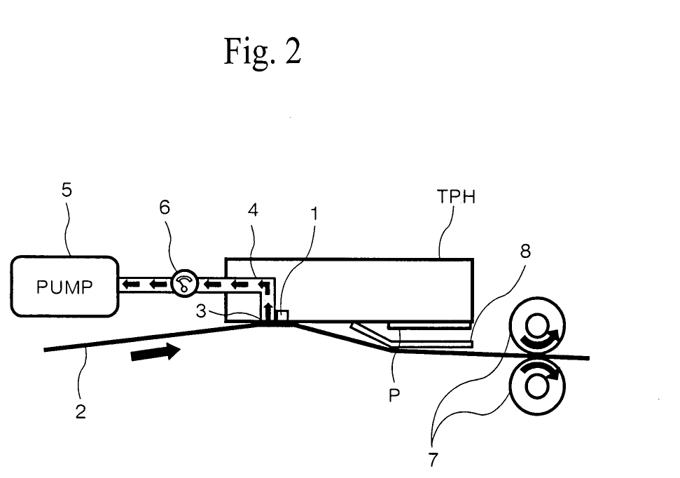

As shown in FIG. 1, this plate-making device includes TPH. The TPH, which is a thin rectangular parallelepiped member, includes plural heating elements 1 juxtaposed in a predetermined interval on a flat bottom along the longitudinal direction (main scanning direction, that is, the vertical direction of paper in FIG. 2) of its external shape. The TPH is disposed so that the bottom is horizontal with the heating elements facing downward. The overall length of a large number of the heating elements 1 juxtaposed in the main scanning direction is smaller than the width (paper width) of the width (paper width) of the main scanning direction of stencil paper 2. In this example, no special fixtures (a circuit board and elements for driving) are provided on the flat bottom of the TPH, and as shown in FIG. 1, stencil paper moves in a horizontal direction along the flat bottom of the TPH.

A suction unit for sucking stencil paper to transport it is provided in the vicinity of the heating elements 1 of the TPH. Specifically, a suction opening 3 serving as the suction unit is opened in a position adjacent to the upstream side of the heating elements 1 with respect to a transportation direction (sub-scanning direction) of stencil paper. The suction opening 3 is an elongated rectangular opening that is about 0.1 mm wide in the sub-scanning direction and about 0 to 0.5 mm apart from the heating elements 1 in the sub-scanning direction. Preferably, the suction opening 3 is provided adjacently to the edge of the heating elements 1 (the interval between the suction opening 3 and the heating elements 1 is 0 mm). A suction passage 4 and a suction pump 5 are connected to the suction opening 3 serving as the suction unit. A suction direction in the suction opening 3 is vertical to the stencil paper 2 (or the flat bottom TPH).

By suction by the suction pump 5, in the suction opening 3 near the heating elements 1 in the upstream side, the stencil paper 2 can be adsorbed to the heating face of the heating elements of the TPH without fail by sucking it with a small pressure of 50 kPa in an upper direction vertical to the sub-scanning direction (transportation direction). Although this adsorption state is a state of stable close contact between the stencil paper 2 and the heating elements 1, when the stencil paper 2 is pulled in a downstream direction by a transporting unit described later, the stencil paper 2 can be stably transported while holding a stable close contact with the heating elements 1.

In this example, the suction passage 4 of the suction unit is incorporated in the TPH, and as described previously, the TPH is shaped as a whole to be compact, thin, and rectangular like normal TPHs. A circuit board, elements, and the like for driving are not provided on the flat face on which stencil paper is guided and transported.

A pressure gauge 6 serving as a suction force detecting unit for detecting the suction force of the suction pump 5 to suck the stencil paper 2 is provided in the middle of the suction passage 4 of the suction unit. It can be confirmed by a pressure value detected by the pressure gauge 6 that the stencil paper 2 is sucked to the suction opening 3 in a required state, and as a result, the stencil paper 2 is in close contact with the heating elements 1 of the TPH in a normal state (stably transportable close contact as described above).

A pair of transportation rollers 7 as a transporting unit for transporting the stencil paper 2 is provided in the downstream side of the heating elements 1 with respect to the transportation direction of the stencil paper 2. The position in which the stencil paper 2 is sandwiched by the pair of transportation rollers 7 is flush with the position in which the stencil paper sucked and held by the suction opening 3 contacts with the heating elements 1, and the flat bottom of the TPH.

According to a positional relation of the components of this example, the stencil paper 2 sandwiched by the transportation rollers 7 that is sucked to the suction opening 3 to bring it into close contact with the heating elements 1, and is flush with the suction opening 3 and the heating elements 1 is smoothly pulled out forwardly along the surface (heating face) of the heating elements 1 or the flat bottom of the TPH provided with the heating elements 1, and delivered forwardly by the transportation rollers 7. In this transportation form, by properly adjusting suction force and the transportation force of the transportation rollers 7, the stencil paper 2 can be stably transported to a next process (a printing part or the like) with high accuracy while holding a state in which the stencil paper 2 contacts closely with the heating elements 1 of the TPH.

With the above-described construction, by sucking the stencil paper 2 by the suction pump 5 and driving the transportation rollers 7 while adhering it to the suction opening 3 and the heating elements 1, the stencil paper 2 can be transported in a horizontal direction without trouble while stably holding close contact of the stencil paper with the heating elements 1, and a desired image or the like can be perforated in the stencil paper 2 with high accuracy by matching a timing to the transportation.

Although, in this example, the suction opening 3 is provided only in the upstream side of the heating elements 1, it may be provided in both the downstream side and the upstream side. In the downstream side, since air is sucked from perforated portions of the stencil paper 2, adhesion force is weak. However, it is no problem that the suction opening 3 is provided supplementary in the downstream side as long as it is provided in the upstream side. In such a case, in comparison with the case where the suction opening 3 is provided only in the upstream side, the force of close contact of the stencil paper 2 with the heating elements 1 becomes stronger. In this case, adjustments can be made to avoid trouble in pullout and transportation of the stencil paper 2 because of increased transportation force of the transportation rollers 7.

### (2) Second Embodiment (FIG. 2)

In the above-described first embodiment, since no projected fixtures such as a circuit board exist on the lower face of the TPH, a simple construction can be formed which allows stencil paper adhered to the suction opening 3 to be transported in a horizontal direction along the bottom. However, some TPHs are provided with projected fixtures such as a circuit board on the bottom. When such TPHs are used, stencil paper cannot be transported in a horizontal direction without deformation as it can be in the first embodiment. However, as described in the second embodiment and subsequent embodiments, even when a fixture exists in external faces of a TPH, a construction can be made which allows stencil paper to be transported without problem by bypassing the projected thing while holding close contact with the heating elements 1 by suction.

A plate-making device of this example shown in FIG. 2 is different from the first example in the construction of a TPH in that a circuit board P (mounted with electronic elements and the like not shown in the drawing) is provided on the bottom of the TPH, and a guide plate 8 for covering it is provided. Since other constructions are the same as those in the first example, the same reference numerals as those in FIG. 1 are assigned and descriptions are omitted as required.

In this example, by suction by the suction pump 5, in the suction opening 3 near the heating elements 1 in the upstream side, the stencil paper 2 can be adsorbed to the heating face of the heating elements of the TPH without fail by sucking it with a small pressure of 50 kPa in an upper direction vertical to the sub-scanning direction (transportation direction). Although this adsorption state is a state of stable close contact between the stencil paper 2 and the heating elements 1, when the stencil paper 2 is pulled in an obliquely downward downstream direction to bypass the guide plate 8 by a transporting unit described later, the stencil paper 2 can be stably transported while holding a stable close contact with the heating elements 1.

A pair of transportation rollers 7 as a transporting unit for transporting the stencil paper 2 is provided in the downstream side of the heating elements 1 with respect to the transportation direction of the stencil paper 2. The position in which the stencil paper 2 is sandwiched by the pair of transportation rollers 7 is somewhat lower than the position of the heating elements 1 of the TPH. The guide plate 8 serving as a guide member provided in the lower face of the TPH in the downstream side with respect to the heating elements 1 also has a function to guide the stencil paper 2 transported.

According to a positional relation of the components of this example, the stencil paper 2 is brought into close contact with the heating elements 1 by being sucked by the suction opening 3, guided by the guide plate 8, and transported while being sandwiched by the transportation rollers 7. The stencil paper 2 is elongated at an acute angle (in this example, preferably, about 15 degrees, or 90 degrees at most) obliquely forwardly (the downstream side) with respect to the surface of the heating elements 1 (heating face) or the horizontal bottom of the TPH provided with the heating elements 1, pulled out forwardly in a substantially horizontal state after passing through the guide plate 8, and delivered forwardly by the transportation rollers 7. Also in this transportation form, by properly adjusting a suction force and the transportation force of the transportation rollers 7 or properly adjusting an angle between the stencil paper 2 pulled out and the bottom of the TPH within 90 degrees, the stencil paper 2 can be stably transported to a next process (a printing part or the like) with high accuracy while holding a state in which the stencil paper 2 contacts closely with the heating elements 1 of the TPH.

With the above-described construction, by sucking the stencil paper 2 by the suction pump 5 and driving the transportation rollers 7 while adhering it to the suction opening 3 and the heating elements 1, the stencil paper 2 can be transported while stably holding close contact of the stencil paper with the heating elements 1, and a desired image or the like can be perforated in the stencil paper 2 with high accuracy by matching a timing to the transportation.

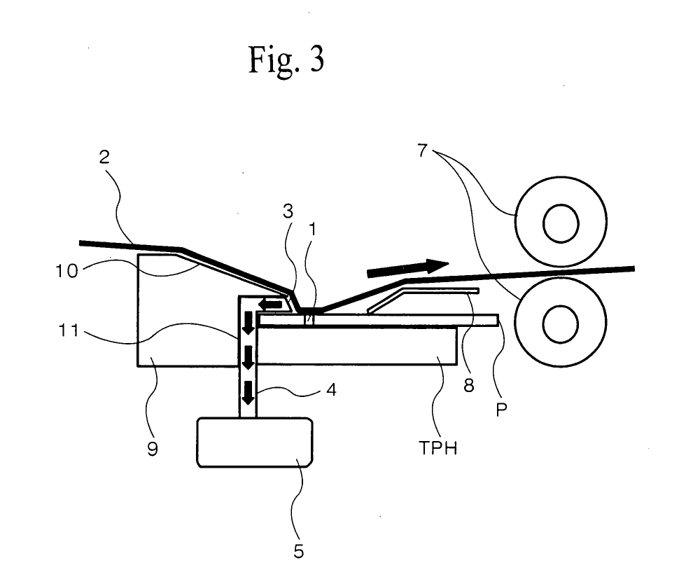

### (3) Third Embodiment (FIG. 3)

Although this example is the same as the first example in basic principle, the suction passage 4 is not incorporated in the TPH and a suction block 9 provided adjacently to the TPH is used to dispose the suction opening 3 in the vicinity of the heating elements 1 of the TPH. The structure and the external shape of the TPH, and the disposition and the number of the heating elements 1 are the same as those in the second example.

In the TPH, the heating elements 1 are disposed to exist on a horizontal upper face, and the suction block 9 of generally trapezoidal shape as viewed from the side that has an oblique face 10 declining toward the heating elements 1 is disposed in an the upstream side (the left side in the drawing) of a transportation direction of the TPH (sub-scanning direction, a lateral direction in the drawing). The suction block 9 has a stepped portion 11 recessed at the side of the TPH at a lower portion of the oblique face 10, the suction passage 4 is provided between the stepped portion 11 and the TPH, and the suction opening 3 opened at the bottom of the oblique face 10 is positioned in the vicinity of the heating elements 1 in the upstream side. A suction direction in the suction opening 3 is almost parallel to the paper face of the stencil paper 2 and a transportation direction (sub-scanning direction), and the direction of suction is opposite (left direction in the drawing) to the direction of transportation (right direction in the drawing). The guide plate 8 exists downstream from the heating elements 1, and the transportation rollers 7 serving as a transporting unit is provided above a further downstream. The construction of the suction pump 5 is the same as that of the first example.

According to a positional relation of the components of this example, the flat sheet-like (sheet-like) stencil paper 2 is guided to the oblique face 10 of the suction block 9 and sucked to the suction opening 3, thereby guided to the guide plate 8 in a state in which the stencil paper 2 is adhered to the heating elements 1, and transported while being sandwiched by the transportation rollers 7. The stencil paper 2 transported in this form is elongated at an acute angle (in this example, preferably, about 15 degrees, or 90 degrees at most) obliquely forwardly (the downstream side) with respect to the surface of the heating elements 1 or the horizontal upper face of the TPH provided with the heating elements 1, pulled out forwardly in a substantially horizontal state after passing through the guide plate 8, and delivered forwardly by the transportation rollers 7. In this transportation form, by properly adjusting a suction force and the transportation force of the transportation rollers 7 or properly adjusting an angle between the stencil paper 2 pulled out and the upper face of the TPH, the stencil paper 2 can be stably transported to a next process (a printing part or the like) with high accuracy while holding a state in which the stencil paper 2 contacts closely with the suction block 9 and the heating elements 1 of the TPH.

With the above-described construction, by sucking the stencil paper 2 by the suction pump 5 and driving the transportation rollers 7 while adhering it to the suction opening 3 and the heating elements 1, the stencil paper 2 can be transported while stably holding close contact of the stencil paper 2 with the heating elements 1, and a desired image or the like can be perforated in the stencil paper 2 with high accuracy by matching a timing to the transportation and arbitrarily driving the heating elements 1.

Other constructions, possible variations, effects, and the like are the same as those of the first example.

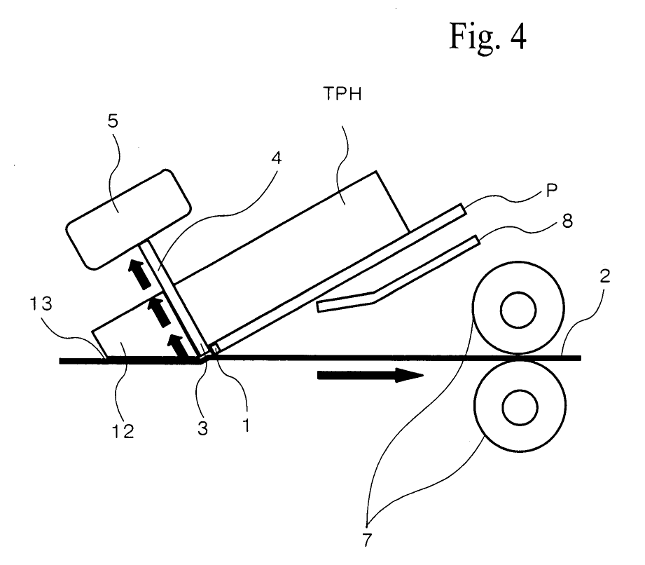

### (4) Fourth Embodiment (FIG. 4)

Although this example is the same as the first example in basic principle, the suction passage 4 is not incorporated in the TPH and a suction block 12 provided adjacently to the TPH is used to dispose the suction opening 3 in the vicinity of the heating elements 1 of the TPH. The TPH is the same as that in the first example in structure, external shape, and the number of the heating elements 1, except that it is a so-called corner type that the heating elements 1 are provided on an upper face side (a lower side when disposed) near a corner of a rear end.

The TPH is disposed so that the heating elements 1 are on a lower face thereof and it is raised (at an oblique angle of about 30 degrees) in the downstream side of a transportation direction (sub-scanning direction), and the suction block 12 of generally trapezoidal shape as viewed from the side that has a horizontal guide face 13 is disposed in the upstream side of a transportation direction of the TPH. The suction block 12 is provided with the suction passage 4 between its front and the rear end face of the TPH, and the suction opening 3 is positioned in the vicinity of the heating elements 1 provided adjacently to the rear end face of the TPH. A suction direction in the suction opening 3 is vertical to the bottom of the TPH, and is about 120 degrees including the above-described oblique angle with respect to the paper face of the stencil paper 2 and the transportation direction (sub-scanning direction). The transportation rollers 7 serving as a transporting unit is provided in the downstream side of the TPH. The construction of the suction pump 5 is the same as that in the first example.

According to a positional relation of the components of this example, the flat sheet-like (sheet-like) stencil paper 2 is guided to the guide face 13 of the suction block 12 and sucked to the suction opening 3, and thereby sandwiched and transported horizontally by the transportation rollers 7 while holding a substantially horizontal state in a state in which the stencil paper 2 is wound in a corner part of the heating elements 1 and contacts closely with its heating face. In this transportation form, by properly adjusting transportation force of the transportation rollers 7 or adjusting a disposition angle of the TPH or an angle of the guide face 13 of the suction block 12 to adjust an angle between the stencil paper 2 transported and the lower face of the TPH, the stencil paper 2 can be stably transported to a next process (printing or the like) with high accuracy while holding close contact of the stencil paper 2 with the suction block 12 and the heating elements 1 of the TPH.

With the above-described construction, by sucking the stencil paper 2 by the suction pump 5 and driving the transportation rollers 7 while adhering it to the suction opening 3 and the heating elements 1, the stencil paper 2 can be transported while stably holding close contact of the stencil paper 2 with the heating elements 1, and a desired image or the like can be perforated in the stencil paper 2 with high accuracy by matching a timing to the transportation and arbitrarily driving the heating elements 1.

Other constructions, possible variations, effects, and the like are the same as those of other embodiments.

### (5) Fifth Embodiment (FIG. 5)

Although this example is the same as the first example in basic principle, the suction passage 4 is not incorporated in the TPH and a suction block 14 provided adjacently to the TPH is used to dispose the suction opening 3 in the vicinity of the heating elements 1 of the TPH. The TPH is the same as that in the first example in structure, external shape, and the number of the heating elements 1, except that it is a so-called end face type that the heating elements 1 are provided at a corner of a rear end.

The TPH is disposed so that the heating elements 1 are in a lower portion of a rear end thereof and vertical to a transportation direction (sub-scanning direction), and a substantially rectangular suction block 14 is disposed in the upstream side of the TPH in the transportation direction. The suction passage 4 is formed in the suction block 14, and the suction opening 3 serving as an opening of the suction passage 4 is positioned in the vicinity of the upstream side of the heating elements 1 of the TPH and somewhat upward of the heating elements 1. A suction direction in the suction opening 3 is parallel to the bottom of the TPH (the right side in the drawing) and vertical to the paper face of the stencil paper 2 and the transportation direction (sub-scanning direction). The transportation rollers 7 are provided in the downstream side of the TPH. The construction of the suction pump 5 is the same as that in the first example.

According to a positional relation of the components of this example, the flat sheet-like (sheet-like) stencil paper 2 is guided to the guide face 15 of the suction block 14 and sucked to the suction opening 3, and thereby sandwiched and transported horizontally by the transportation rollers 7 while holding a substantially horizontal state in a state in which the stencil paper 2 is wound in engagement with a corner part of the heating elements 1 and contacts closely with its heating face. In this transportation form, by properly adjusting transportation force of the transportation rollers 7, the stencil paper 2 can be stably transported to a next process (printing or the like) with high accuracy while holding close contact of the stencil paper 2 with the suction block 14 and the heating elements 1 of the TPH.

With the above-described construction, by sucking the stencil paper 2 by the suction pump 5 and driving the transportation rollers 7 while adhering it to the suction opening 3 and the heating elements 1, the stencil paper 2 can be transported while stably holding close contact of the stencil paper 2 with the heating elements 1, and a desired image or the like can be perforated in the stencil paper 2 with high accuracy by matching a timing to the transportation and arbitrarily driving the heating elements 1.

Other constructions, possible variations, effects, and the like are the same as those of other embodiments.

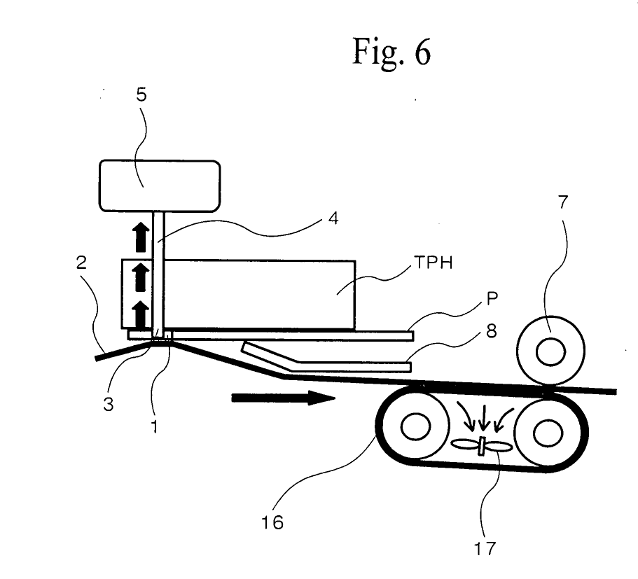

### (6) Sixth Embodiment (FIG. 6)

Although the transporting unit is constructed with a pair of the transportation rollers in the above-described embodiments, other constructions may be adopted. In a sixth embodiment shown in FIG. 6, a transporting unit including lower belt rollers 16 and an upper roller 7 rotating in contact with it is provided in the downstream side of the TPH. The belt rollers 16 are provided with a suction unit 17 so that the stencil paper 2 above it can be sucked and held via the breathable belt, and the stencil paper 2 sandwiched by the transportation roller 7 and the belt rollers 16 can be transported downstream while being securely held.

According to this example, in comparison with the case of using a pair of transportation rollers 7, slips occur less frequently, the operation of transporting the stencil paper 2 downstream is surer, and a plate-making state is more improved. Other constructions, effects and advantages, and variations are generally the same as those in the second embodiment. Portions in this example that correspond in other embodiments are assigned the same reference numerals and descriptions of them are omitted.

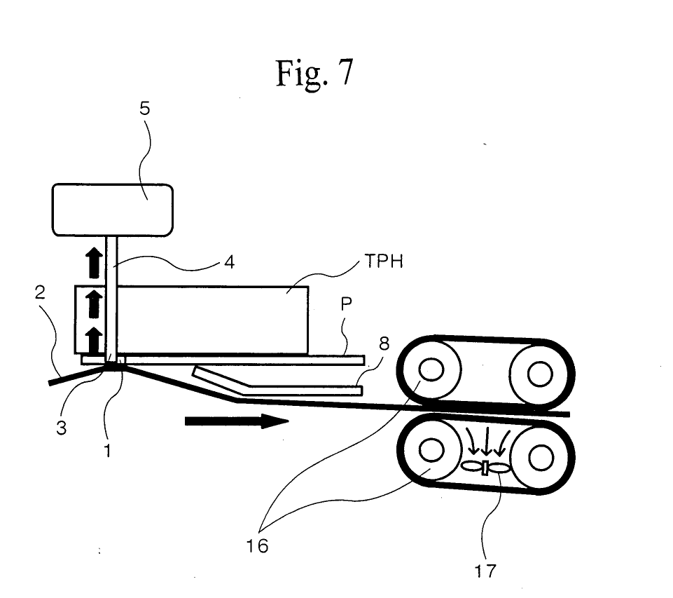

### (7) Seventh Embodiment (FIG. 7)

In a seventh embodiment shown in FIG. 7, in the downstream side of the TPH, a transporting unit including an upper belt roller 16 and a lower belt roller 16 that rotate in contact with it is provided. The lower belt roller 16 is provided with a sucking unit 17 so that the stencil paper 2 between the upper and lower belt rollers 16 and 16 can be correctly sucked and held without deviation via the breathable belts, and the stencil paper 2 sandwiched by the both belt rollers 16 and 16 can be transported downstream while being securely held.

According to this example, in comparison with the sixth embodiment, slips occur less frequently, the operation of transporting the stencil paper 2 downstream is surer, and a plate-making state is more improved. Other constructions, effects and advantages, and variations are generally the same as those in the second embodiment. Portions in this example that correspond in other embodiments are assigned the same reference numerals and descriptions of them are omitted.

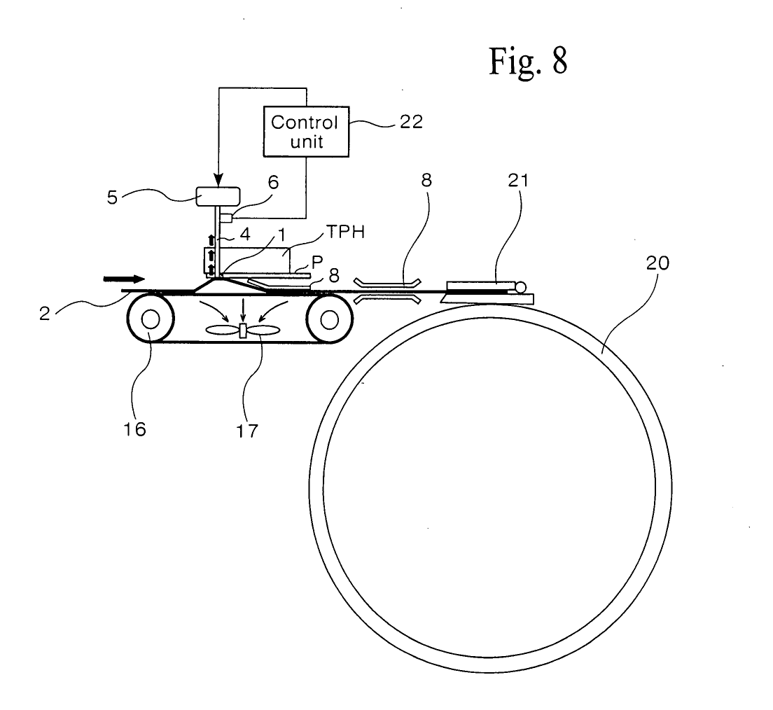

### (8) An Eighth Embodiment (FIG. 8)

In an eighth embodiment shown in FIG. 8, the lower belt rollers 16 having the suction unit 17 in the sixth embodiment of FIG. 6 have a long transportation length from the downstream side to the upstream side of the heating elements 1, further the upper transportation roller 7 is removed, and a printing drum 20 as a printing unit disposed downstream of the plate-making device is used.

A printing drum 20 includes an ink permeable circular plate cylinder, a clamp plate 21 provided in the outer circumference of the place cylinder to nip and hold the tip of the stencil paper 2, and an ink supplying unit (not shown in the drawing) provided inside the plate cylinder, and is rotationally driven around the central shaft of the plate cylinder. A pressing roller (not shown in the drawing) is vertically movably provided in a lower portion of the printing drum 20.

In this example, a pressure detecting unit such as the pressure gauge 6 as described in the second embodiment is provided in the middle of the suction passage 4 of the sucking unit. The detection signal is sent to a control unit 22, which determines whether a current suction force is optimum from the signal, and on determining that adjustments are necessary, sends a control signal to the suction pump 5 as the sucking unit to adjust a suction force.

Other constructions are the same as those in the sixth embodiment.

During printing, the printing drum 20 rotates with the tip of the stencil paper 2 nipped by the clamp plate 21, and the stencil paper 2 is transported. In the meantime, the suction pump 5 is continuously driven, the TPH is selectively driven in timing suitable for the transportation of the stencil paper 2, and the stencil paper 2 is wound on the circumferential wall of the printing drum 20 while the stencil paper 2 is subjected to necessary perforation. In the meantime, since suction force is maintained to be optimum by the pressure gauge 6 and the control unit 22, a state of close contact of the stencil paper 2 with the heating elements 1 is satisfactory.

After the stencil paper 2 is wound, as the printing drum 20 is rotated, print paper is fed to a gap between the printing drum 20 and the pressing roller at a predetermined timing, the pressing roller rises in line with the timing to sandwich the print paper between the pressing roller and the printing drum 20, and thereby the print paper is printed according to a perforated image and forwardly ejected while being transported by the printing roller and the pressing roller.

According to this example, slips during transportation in the seventh embodiment occur much less frequently, the operation of transporting the stencil paper 2 downstream is more secure, and a plate-making state is further improved. Other constructions, effects and advantages, and variations are generally the same as those in the second embodiment. Portions in this example that correspond in other embodiments are assigned the same reference numerals and descriptions of them are omitted.

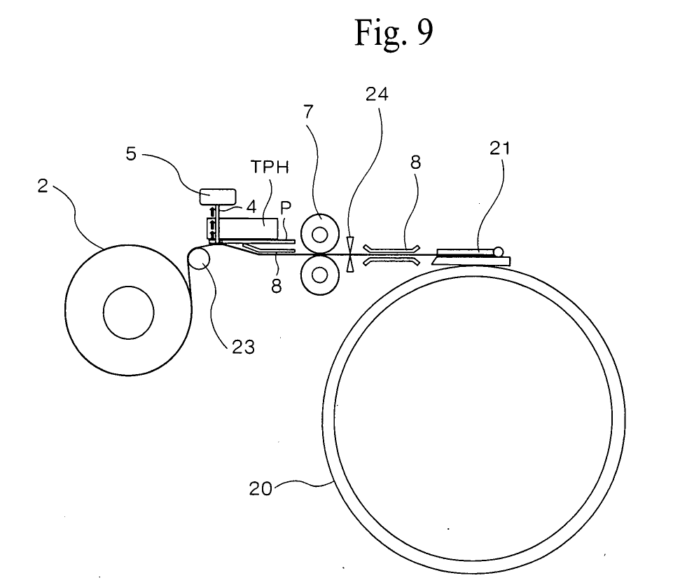

### (9) Other Embodiments (FIG. 9)

Although the illustrated stencil paper 2 described in the respective embodiments described above is flat sheet-like (sheet-like), the stencil paper 2 wound in a roll may be used. FIG. 9 shows a state in which the stencil paper 2 is fed. Specifically, the stencil paper 2 is pivoted in a rotatable manner in an adjacent portion of the upstream side of the TPH, and delivered stencil paper 2 is sent to the TPH via a guide shaft 23. A cutter 24 for cutting long stencil paper 2 delivered from the stencil paper 2 in a roll to a proper length is provided further downstream of the transportation rollers 7 disposed downstream of the TPH. Although not shown in FIG. 9, like the eighth embodiment (FIG. 8), the recording apparatus may be constructed to achieve an optimum suction force by the pressure gauge 6 and the control unit 22.

The effects and advantages of the apparatus in this example are described.

A roll of the stencil paper 2 is set in a predetermined position, the stencil paper 2 delivered from the roll is passed through the transportation path of the plate-making device and the transportation roller 7, and the tip of the stencil paper 2 is positioned using a sensor not shown in the drawing. Specifically, a plate-making start button is pressed to actuate the transportation rollers 7, the stencil paper 2 is stopped in a predetermined position, and the printing drum 20 is stopped in a position where the clamp plate 21 is set in a predetermined clamp position. In plate making, the stencil paper 2 is introduced to the clamp plate 21 and held in a sandwiched manner by rotating the clamp plate 21, and after confirming a predetermined value of suction pressure by activating the suction pump 5, the printing drum 20 is rotated synchronously with the activation of the transportation rollers 7. In the mean time, the heating elements 1 of the TPH are selectively heated according to the transportation of the stencil paper 2, and the stencil paper 2 is perforated. After the termination of the plate making, the suction pump 5 is stopped, the transportation rollers 7 are stopped, and the stencil paper 2 is cut by the cutter 24. By this construction, the stencil paper 2 can be made into a plate and wound around the printing drum 20.

### (10) Embodiments in Other Fields to Which the Present Invention is Applicable

In the above-described embodiments described above, stencil paper is made into a plate by a plate-making device. The stencil paper includes the one with a support of a synthetic fiber pasted together to a thermoplastic resin film and the one with a support of a natural fiber pasted together to a thermoplastic resin film, in addition to the one including only a thermoplastic resin film (so-called support-less master).

Furthermore, the thermal recording apparatus of the present invention includes a thermal recording apparatus that performs thermal recording on thermal paper. In this case, since thermal paper after the thermal recording cannot be perforated as in stencil paper having been made into a plate, unlike the embodiments of the plate-making devices, a sucking unit for sucking thermal paper may be disposed downstream of the heating elements 1. Of course, it may be disposed in the upstream side, and if it is disposed both in the upstream side and the downstream side, sucking and holding force will be further increased.

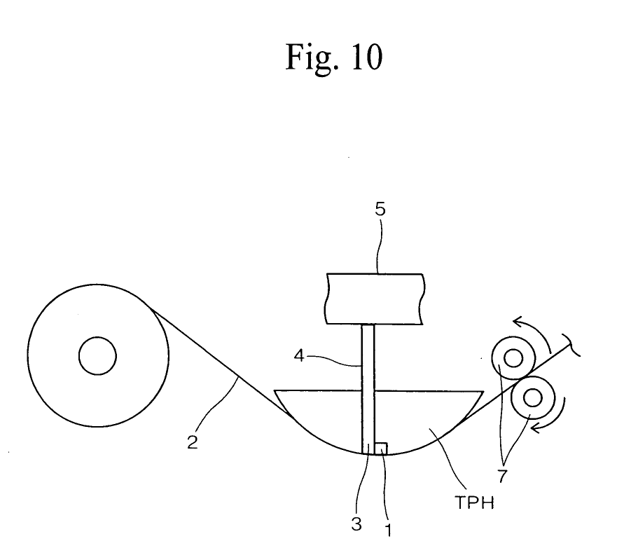

### (11) Embodiment Including a Thermal Head with a Curved Surface (FIG. 10)

In an embodiment shown in FIG. 10, the surface (a lower face in the drawing) of a thermal head TPH provided with the heating elements 1 and the suction opening 3 of the sucking unit is convex, curved in both of both the forward and the backward positions of the heating elements 1 and the suction opening 3 with respect to a transportation direction of the stencil paper 2. The roll of stencil paper as a source of supplying the stencil paper 2 is disposed nearer the curvature center of the curved surface in comparison with the heating elements 1 and the suction opening 3 in the forward side of the thermal head TPH with respect to the transportation direction, and the transportation rollers 7 are disposed nearer the curvature center of the curved surface in comparison with the heating elements 1 and the suction opening 3 in the backward side of the thermal head TPH with respect to the transportation direction.

Therefore, if the stencil paper 2 is transported by the transportation rollers 7 while being sucked by the sucking unit, as shown in FIG. 10, since the stencil paper 2 is transported while being wound on the convex face of the thermal head TPH provided with the heating elements 1, adhesion of a thermal recording medium to the heating elements during plate making is further increased. Other constructions, effects and advantages, and variations are generally the same as those in the second embodiment. Portions in this example that correspond in other embodiments are assigned the same reference numerals and descriptions of them are omitted.

The respective components in plural embodiments described above can be properly combined as another embodiment within the same scope of the present invention. In this case, effects and advantages of the present invention corresponding to the combined components are obtained.

As seen from the above-described embodiments, according to the present invention, effects and advantages as described below will be obtained.

According to the thermal recording apparatus described in claim 1, since a thermal recording medium is brought into close contact with the heating elements of the TPH by the sucking unit disposed in the vicinity of the heating elements, and is transported by the transporting unit provided in the downstream side with respect to a transportation direction, the thermal recording medium can be brought into close contact with the heating elements of the TPH by a relatively small force (energy) of the sucking unit, and can be transported with high accuracy while holding the state.

Specifically, unlike a conventional structure having mechanically extremely large burdens because a thermal recording medium is pressed against the TPH with a great force by using rotating platen rollers, due to a reasonable structure in which smaller mechanical burdens are placed on parts of the apparatus and a thermal recording medium because a thermal recording medium brought into close contact with the heating elements with relatively small suction energy is pulled out and transported in the sub-scanning direction while being held in the close contact state, the thermal recording medium can be efficiently brought into fully close contact with the heating elements, and high transportation accuracy can be achieved. As a result, stable thermal recording (e.g., thermal perforation to stencil paper by a plate-making device) faithful to paper can be performed. Moreover, the exclusion of platen rollers makes the structure simple and compact, and achieves miniaturization and reduction in costs because of the disuse of pressure by the platen rollers in the TPH, so that significant miniaturization and reduction in costs can be achieved as the whole apparatus.

Stencil paper sucked by the sucking unit into close contact with the heating elements of the TPH is pulled out by the transporting unit in the sub-scanning direction orthogonal to a suction direction, and transported directly in a horizontal direction along the flat outer face of the TPH. This is preferable because of less possible transportation trouble. However, when a projection or the like obstructive to the transportation of the stencil paper exists on the outer face of the TPH, it is possible to pull out and transport the stencil paper by the transporting unit at a somewhat angle with respect to a close contact position between a suction location and the heating elements, in which case the suction force of the sucking unit may be properly adjusted.

According to the thermal recording apparatus described in claim 2, when stencil paper with relatively low stiffness is thermally perforated, if the sucking unit is provided at least in the upstream side of the heating elements, the effects and advantages as described above can be obtained.

According to the thermal recording apparatus described in claim 3, when thermal paper with relatively high stiffness is thermally recorded, if the sucking unit is provided at least one of the upstream side and the downstream side of the heating elements, the effects and advantages as described above can be obtained.

According to the thermal recording apparatus described in claim 4, in the thermal recording apparatus described in claims 1 to 3, since the sucking unit can detect suction force to suck a thermal recording medium, determination of whether the thermal recording medium is sucked as well as adjustments of the suction force can be made based on a result of the detection.

According to the thermal recording apparatus described in claim 5, in the thermal recording apparatus described in claim 4, by controlling a suction force by the sucking unit according to a result of detection of the suction force detecting unit, the force to hold the thermal recording medium can be optimally maintained to bring the thermal recording medium into close contact the heating elements of the TPH in a satisfactory state.

According to the thermal recording apparatus described in claim 6, in the thermal recording apparatus according to claim 1, without air leaking from the suction opening of the sucking unit, the thermal recording medium is brought into firmly close contact with the heating elements by suction.

According to the thermal recording apparatus described in claim 7, in the thermal recording apparatus according to claim 6, all of the heating elements juxtaposed in the main scanning direction can be brought into close contact with a thermal recording medium.

According to the thermal recording apparatus described in claim 8, in the thermal recording apparatus described in claim 1, since the surface of the thermal head provided with the heating elements and the sucking unit is of convex shape, curved before and after the heating elements and the sucking unit, if a thermal recording medium is transported while being sucked by the sucking unit, since the thermal recording medium is wound on the surface of the thermal head, adhesion of the thermal recording medium to the heating elements during plate making is further increased.

What is claimed is:

1. A thermal recording apparatus that transports a thermal recording medium in a sub-scanning direction in close contact with a thermal print head including plural heating elements juxtaposed in a main scanning direction, and performs thermal recording on the thermal recording medium by arbitrarily driving the heating elements, comprising:
a sucking unit that is provided in the vicinity of the heating elements, and sucks and transportably holds the thermal recording medium, and
a transporting unit that is provided in the downstream side of the heating elements with respect to a transportation direction of the thermal recording medium, and transports the thermal recording medium,
wherein the thermal recording apparatus transports the thermal recording medium in close contact with the heating elements by transporting the thermal recording medium by the transporting unit while sucking it by the sucking unit, and performs thermal recording on the thermal recording medium by arbitrarily driving the heating elements.

2. The thermal recording apparatus according to claim 1, wherein the thermal recording medium is stencil paper, and the sucking unit is provided at least in the upstream side of the heating elements.

3. The thermal recording apparatus according to claim 1, wherein the thermal recording medium is thermal paper, and the sucking unit is provided in at least one of the upstream side and the downstream side of the heating elements.

4. The thermal recording apparatus according to claim 1, wherein the sucking unit includes a sucking force detecting unit that detects a suction force with which the sucking unit sucks the thermal recording medium.

5. The thermal recording apparatus according to claim 4, including a control unit that controls the suction force of the sucking unit according to a detection result of the suction force detecting unit.

6. The thermal recording apparatus according to claim 1, wherein the sucking unit has a suction opening with a main scanning direction of the thermal recording medium as a longitudinal direction, and a length of the suction opening in the main scanning direction is smaller than a width of the thermal recording medium in the main scanning direction.

7. The thermal recording apparatus according to claim 6, wherein a width of the heating elements in the main scanning direction is smaller than the length of the suction opening in the main scanning direction.

8. The thermal recording apparatus according to claim 1, wherein a surface of the thermal print head provided with the heating elements and the sucking unit is of convex shape, curved in both of a forward position and a backward position of the heating elements and the sucking unit with respect to a transportation direction of the thermal recording medium, and the thermal recording medium transported by the transporting unit contacts closely with the surface in the both positions.
